(19) United States
(12) Patent Application Publication
(10) Pub. No.: US 2015/0278299 A1
(43) Pub. Date: Oct. 1, 2015

(54) EXTERNAL MERGE SORT METHOD AND DEVICE, AND DISTRIBUTED PROCESSING DEVICE FOR EXTERNAL MERGE SORT

(71) Applicant: Research & Business Foundation SUNGKYUNKWAN UNIVERSITY, Suwon-si (KR)

(72) Inventors: Jin-Soo KIM, Seoul (KR); Young-Sik LEE, Gwangmyeong-si (KR)

(73) Assignee: Research & Business Foundation SUNGKYUNKWAN UNIVERSITY, Suwon-si (KR)

(21) Appl. No.: 14/570,210

(22) Filed: Dec. 15, 2014

(30) Foreign Application Priority Data
Mar. 31, 2014 (KR) 10-2014-0037376

(51) Int. Cl. G06F 17/30; G06F 7/36

(52) U.S. Cl. CPC G06F 17/30424; G06F 7/36

(57) ABSTRACT

An external merge sort method includes inputting source data, storing, by a computer device, a plurality of runs in a storage device, the plurality of runs being obtained by dividing and internally sorting source data according to a size processable in a memory, performing, by the storage device, a merge sort on the stored runs using embedded software and accessing, by the computer device, the sorted data.

### CROSS-REFERENCE TO RELATED APPLICATION

This application claims priority to and the benefit under 35 U.S.C. §119(a) of Korean Patent Application No. 10-2014-0037376, filed on Mar. 31, 2014, in the Korean Intellectual Property Office, the entire disclosure of which is incorporated herein by reference for all purposes.

### BACKGROUND

1. Field

The following description relates to an external merge sort method and an apparatus that performs an external merge sort.

2. Description of Related Art

Techniques for performing an external merge sort are often used to sort data managed by a distributed processing device that processes large-scale data, such as, for example, Hadoop, and a database system that manages large-scale data. The use of external merge sort techniques is due to an exponentially increasing amount of data handled by a system and a limited capacity of a memory that processes the amount of data. A device for performing an external merge sort includes a host device configured to control a process of the external merge sort and a storage device configured to store data generated during the sort process.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, there is provided an external merge sort method including storing, by a computer device, a plurality of runs in a storage device, the plurality of runs being obtained by dividing and internally sorting source data according to a size processable in a memory, performing, by the storage device, a merge sort on the stored runs using embedded software, and accessing, by the computer device, the sorted data.

The external merge sort method may include, delivering, by the computer device, run information comprising a storage position and a file size of each of the plurality of runs to the storage device, before the performing of the merge sort.

The run information may include at least one of a record size of data included in the run, a position of a key value, a length of a key value, or a record type.

The performing of the merge sort may include sequentially storing, by the storage device, records included in the runs in a buffer or main storage medium of the storage device according to a key value of each record and a sort criterion.

The performing of the merge sort may occur in response to the storage device receiving an instruction to read output data from the computer device, or in response to the storage device receiving a merge instruction from the computer device, or in response to the storage device being in an idle state in which the merge sort is enabled.

In the performing of a merge sort, the storage device may store the sorted data in a buffer in units of a size of the buffer, and wherein in the accessing of the merged and sorted data, the computer device may receive the data stored in the buffer in units of the size of the buffer.

In the performing of the merge sort, the storage device may store the sorted data in a main storage medium, and wherein in the accessing of the merged and sorted data, the computer device may read the data stored in the main storage medium.

The storage device may be a non-volatile memory or flash memory.

In another general aspect, there is provided an external merge sort system including a host device configured to store a plurality of runs in a storage device, the plurality of runs being obtained by performing an internal sort on source data in units of a reference segment size processable in a memory and to deliver a merge sort instruction for the plurality of runs to the storage device, and a storage device configured to receive the merge sort instruction, to perform a merge sort on the plurality of runs, and to deliver the sorted data to the host device.

The host device may receive the source data from the storage device, a separate storage device, or a storage device connected over a network.

The host device may deliver run information including at least one of a storage position of each run, a file size, a record size of data included in the run, a position of a key value, a length of a key value, or a record type to the storage device, and wherein the storage device performs the merge sort using the run information.

The storage device may include a main store configured to store the runs, a buffer configured to store the sorted data, an interface configured to deliver the sorted data stored in the buffer to the host device, and a controller configured to control the interface to sequentially store the records included in the runs in the buffer according to a key value of each record and a sort criterion and to deliver the data stored in the buffer to the host device.

The host device may deliver the merge sort instruction to the storage device in response to an access to output data stored in the storage device being needed or in response to the storage device being in an idle state.

The storage device may store the data sorted by performing the merge sort in a buffer and delivers the data stored in the buffer to the host device, or store the data sorted by performing the merge sort in a main storage medium and delivers the data stored in the main storage medium to the host device in response to a request by the host device.

In another general aspect, there is provided a distributed processing system for external merge sort including first merge sort devices configured to internally sort first-divided source data in units of a size processable in a memory of each first merge sort device in response to source data being first-divided and transmitted by each first merge sort device, to store the runs sorted in units of the size in a first storage device, and to perform a first merge sort on the runs to deliver the sorted data to the second merge sort device, and a second merge sort device configured to receive the first merged and sorted data from each of the first merge sort devices and to perform a second merge sort on the first merged and sorted data to store the sorted data in a second storage device.

The first merge sort device may be further configured to store a result of performing the first merge sort in a buffer and to deliver the data stored in the buffer to the second merge sort device, or to store a result of performing the first merge sort on the runs in a first storage device and to deliver the sorted data to the second merge sort device when the sort is completed.

The distributed processing system may include a host device configured to control at least one of the first division of the source data, the first merge sort, the delivery of the runs, or the second merge sort.

The host device may deliver run information including at least one of a storage position of each run, a file size, a record size of data included in the run, a position of a key value, a length of a key value, or a record type to the first merge sort device, and wherein the first merge sort device may perform the first merge sort independently using the run information.

The second merge sort device may be a host device, and the host device may store the first merge sort data in the second storage device and performs the second merge sort using the first merged and sorted data that is stored in the second storage device.

At least one of the first storage device and the second storage device may be a non-volatile memory or flash memory.

Other features and aspects will be apparent from the following detailed description, the drawings, and the claims

### BRIEF DESCRIPTION OF THE DRAWINGS

FIG. 1 is a diagram illustrating an example of a traditional external merge sort.

FIG. 2 is a diagram illustrating an example of an external merge sort.

FIG. 3 is a diagram illustrating an example of an external merge sort.

FIG. 4 is a diagram illustrating an example of external merge sort.

FIG. 5 is a diagram illustrating an example of external merge sort.

FIG. 6 is a diagram illustrating an example of external merge sort system.

FIG. 7 is a diagram illustrating an example of distributed processing system for external merge sort.

FIG. 8 is a diagram illustrating an example of distributed processing system for external merge sort.

Throughout the drawings and the detailed description, unless otherwise described, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Data can be various kinds or types, but should have a reference value to be sorted. Data itself may have a size value. In addition, data may include main data having no size value and a size value corresponding to the main data. The data, which is an object of the sort, may be various forms and kinds of data, which will be apparent to one of ordinary skill in the art. For convenience of description, hereinafter, it is assumed that the data, which is an object of the sort, is in the form of a record. The record includes a key having a variable length and a key value stored in the key. As a result, the sort is performed based on the key.

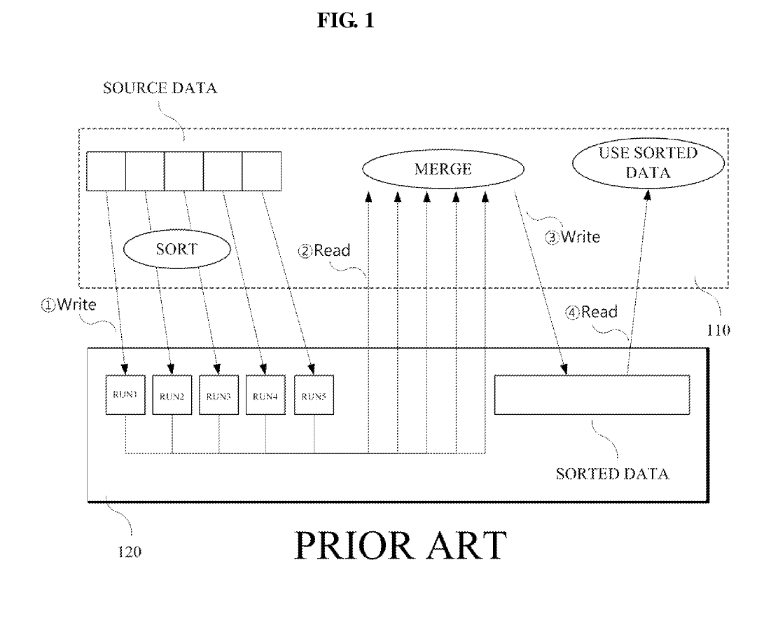

First, an example of an external merge sort in the prior art is briefly described. FIG. 1 is a diagram illustrating an example of a traditional external merge sort. The sort is performed by a host device 110 configured to perform an operation and a control of the sort. A storage device 120 configured to store data generated during the sort.

First, source data that is an object of the sort is needed. The source data may be data previously stored in the storage device 120 or data delivered through a network or an auxiliary storing device, such as, for example, a Universal Serial Bus (USB), a hard disk drive, a solid state disk (SSD), other than the storage device 120.

The host device 110 divides source data according to a size that can be processed in a memory of the host device 110. The host device 110 may partition the source data according to a size that can be processed in the memory in advance or may process the source data in real time while reading the source data from the memory. The size of the memory differs by device, and the size of the equipped memory may be different from the size of the data that can be internally sorted. A unit where the source data is partitioned is referred to as a memory size unit. In FIG. 1, elements such as a memory and the like of the host device 110 are not shown.

The host device 110 internally sorts source data that is input to the memory. A variety of well-known techniques may be used as an internal sorting technique, such as, for example, the internal sort technique includes various techniques such as a bubble sort, an insertion sort, a quick sort. Source data of a memory size unit that is obtained by the host device 110 that completes the internal sort is considered as one run. A part of the source data, which is sorted in memory size units, is referred to as a run. The host device 110 internally sorts the source data in memory size units according to a certain order and stores a plurality of runs obtained through the sort in the storage device 120. FIG. 1 shows an example in which five runs RUN1, RUN2, RUN3, RUN4, and RUN5 are stored in a storage device.

When the internal sort is completely performed on all source data in memory size units, the host device 110 merges the plurality of runs stored in the storage device 120 into one data set (file). Various techniques known to one of ordinary skill in the art may be used to merge the plurality of runs into one sorted data set. For example, an m-way merge may be used, and also one file may be made while records are read one by one according to a sort criterion, that is, in order of ascending or descending priority with reference of all of the plurality of runs. The m-way merge has an increased number of reads and writes performed in the storage device, thus, one file may be made with reference to all of the plurality of runs. Final result data (sort data) is stored in the storage device 120.

A merge process performed by the host device 110 is a method of loading the records to the memory of the host device 110 one by one with reference to the plurality of runs according to a sort criterion and storing sorted data in the storage device 120 when a part available in the memory is filled with the sorted data.

After all of the source data is stored in the storage device 120 in a sorted order, the host device 110 reads and uses the sorted data if necessary.

A process of performing an external merge sort and an operation of utilizing the sorted data include storing, by the host device 110, a plurality of runs in a storage device (1^{st} Write), reading, by the host device 110, data to merge the plurality of runs (1^{st} Read), storing, by the host device 110, merged and sorted data in the storage device (2^{nd} Write), and reading and using, by the host device 110, the sorted data (2^{nd} Read). In the above process, a total of two writes and two reads are performed.

When initial source data is stored in the storage device 120, one read may be further performed. However, hereinafter, a process of inputting the source data will be omitted from this description.

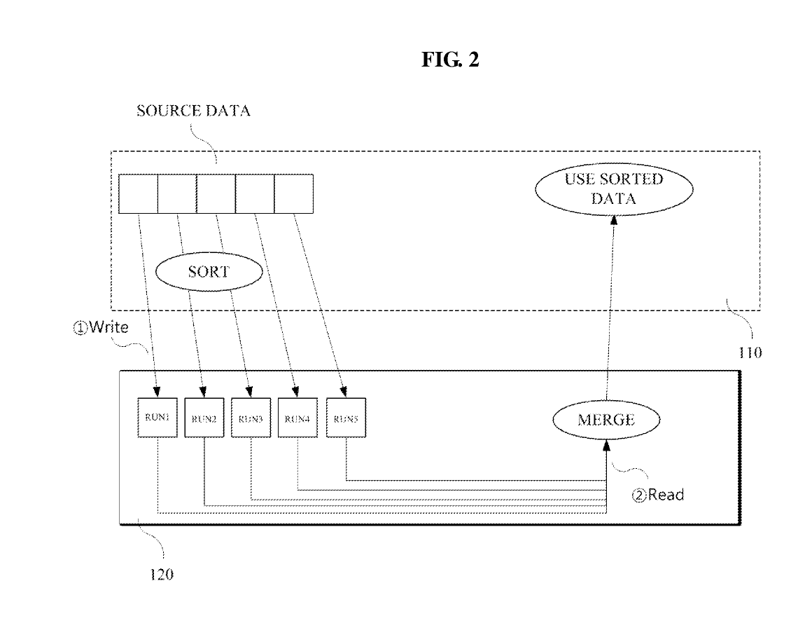

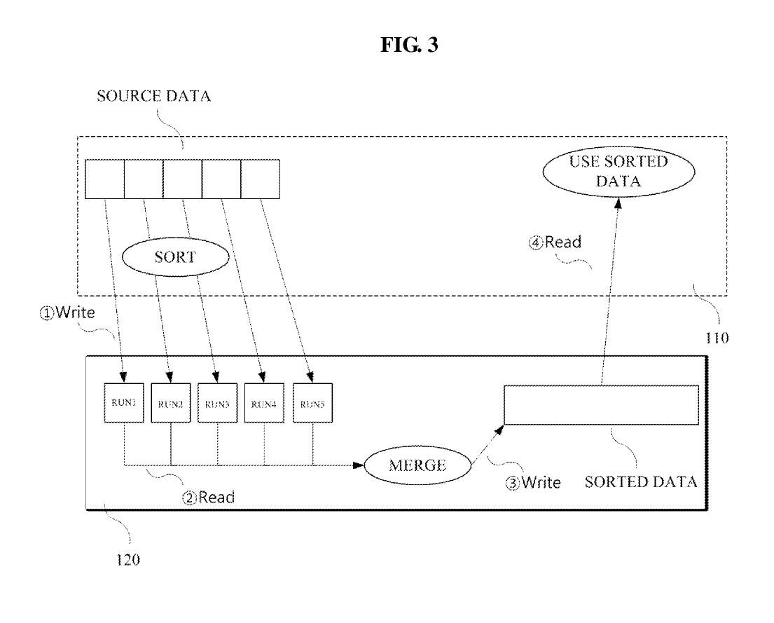

External merge sort methods 400, 500, an external merge sort device 100, and distributed processing device for external merge sort 200 and 300 will be described in detail below. It is noted that like elements corresponding to the related art shown in FIG. 1 may be assigned like reference numerals. FIG. 2 is a diagram illustrating another example of an external merge sort. And FIG. 3 is a block diagram illustrating still another example of performing an external merge sort.

As shown in FIG. 2, a process of the host device 110 internally sorting the source data in memory size units and storing a plurality of runs in the storage device 120 is the same as in FIG. 1. However, a portion of a merge sort process is distributed to the storage device 120. To perform the merge process, the storage device 120 needs a processor for performing the merge process. The storage device 120 may include a chip in which embedded software for the merge process is installed.

The host device 110 may deliver information needed for the merge while the host device 110 stores the plurality of runs in the storage device 120 or at least before the storage device 120 performs the merge process. The needed information includes information, such as, for example, a data position in the storage device and a file size. In addition, information on a size of a record and a length and type of a key may be passed to the storage device. Hereinafter, the information needed for the merge process is referred to as “run information.”

An operation of the storage device 120 merging the plurality of runs may be performed when an instruction for reading the output data (sorted output data) is delivered from the host device 110. Alternatively, the operation of merging the plurality of runs may be performed when a separate merge instruction is delivered from the host device 110. Furthermore, the operation of merging the plurality of runs may be performed automatically by the storage device 120, i.e., the operation may be performed when the storage device 120 is in an idle state.

FIG. 2 shows an example in which the storage device 120 merges a plurality of runs, stores the merged runs in a buffer, not in its storage, and delivers content stored in the buffer to the host device 110 when the buffer is full. In FIG. 2, elements such as a buffer and the like of the storage device 120 are not shown. Subsequently, the host device 110 uses the merged and sorted data.

When an external merge sort technique is used as shown in FIG. 2, one write (1^{st} Write) and one read (1^{st} Read) are performed in the storage device 120. When the number of reads and writes in the storage device 120 is reduced, the external merge sort may be more quickly performed, and furthermore a life of the storage device 120 may be increased.

A solid state disk (SSD) has a write speed less than a read speed. When a write process is reduced by one time, a merge sort may be performed even more quickly. Moreover, when the storage device 120 uses, as a storage medium, a flash memory having a limited life such as the SSD, the lifetime of the flash memory is increased significantly by using a method as shown in FIG. 2.

FIG. 3 shows an example of an external merge sort different from that of FIG. 2. In FIG. 3, the storage device 120 stores sorted data obtained by merging a plurality of runs. Subsequently, when the host device 110 needs sorted output data, the host device 110 reads and uses the sorted data stored in the storage device 120.

An external merge sort technique as shown in FIG. 3 uses two reads and two writes, like in the related art. Accordingly, the number of reads and writes is not reduced. However, it is advantageous in that energy consumption of the host device 110 may be reduced because the host device 110 does not merge a plurality of runs. Of course, the external merge sort technique shown in FIG. 2 may reduce overhead or energy consumption of the host device 110 as well.

When the host device 110 repeatedly uses final sorted data, it is desirable to use a method of storing the sorted data in the storage device 120.

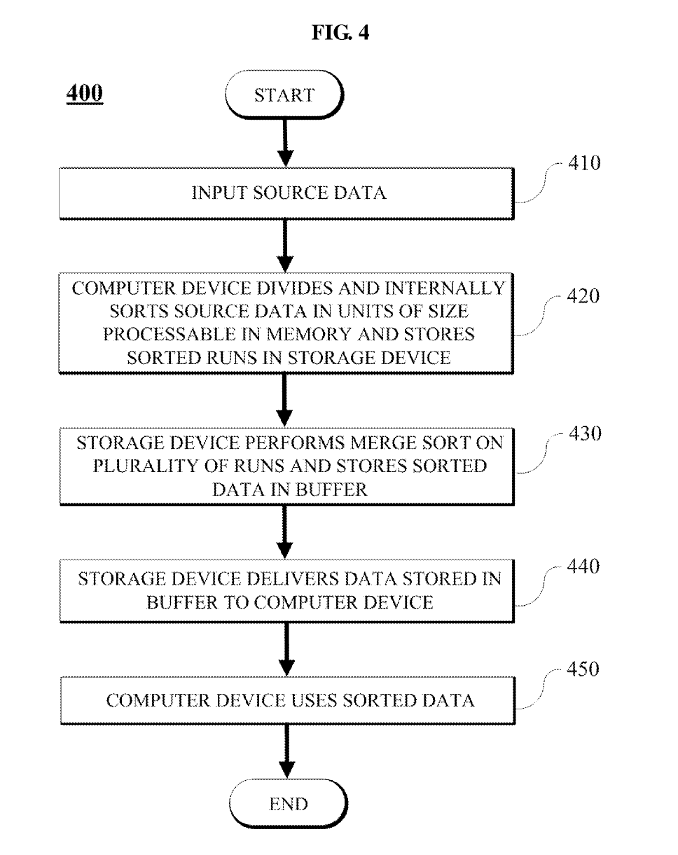

FIG. 4 is a flowchart illustrating an example of external merge sort method 400. The operations in FIG. 4 may be performed in the sequence and manner as shown, although the order of some operations may be changed or some of the operations omitted without departing from the spirit and scope of the illustrative examples described. Many of the operations shown in FIG. 4 may be performed in parallel or concurrently. The above descriptions of FIGS. 1-3, are also applicable to FIG. 4, and is incorporated herein by reference. Thus, the above description may not be repeated here.

In step 410, the source data is input for the external merge sort method 400. In step 420, the source data is divided and internally sorted, by a computer device, in memory size units and the sorted runs is stored in the storage device 120. In step 430, a merge sort on the plurality of runs is performed, by the storage device 120, and the sorted data is stored in a buffer, In step 440, the data stored in the buffer is delivered, by the storage device 120, to the computer device. In step 450, the sorted data is used by the computer device.

The computer device is a device that uses the sorted data and corresponds to the above-described host device 110. The storage device 120 may be a storage medium configured as a non-volatile memory or flash memory, such as, for example, a solid state disk (SSD) or a storage medium, such as, for example, a hard disk.

Before the storage device 120 performs a merge sort on a plurality of runs, the computer device 110 may deliver run information including a storage position and a file size of each of the plurality of runs to the storage device. For example, the computer device 110 may deliver the run information while internally sorting source data in memory size units and storing the data sorted in memory size units in the storage device 120. In addition, the run information may further include information, such as, for example, at least one of a record size of data included in the run, a position of a key value, a length of a key value, and a record type.

Since the storage device 120 may access data in order to perform a merge sort on the plurality of runs, positions and sizes of the runs are needed. In addition, in order to merge runs, a size of a record constituting each run is needed. If there is a separate key value, data may need information about a position and/or a length of the key value. When the sizes of the key and the record are variable, the key and the record may be accessed using a method of adding a header to the record.

In the external merge sort method 400, in step 430, the storage device 120 stores a result of sequentially sorting the runs according to a sort criterion and a key value of each record while merging the plurality of runs and, in step 440, delivers data stored in the buffer to the computer device when the buffer is filled with the data. The storage device 120 stores and delivers data in buffer-size units of the storage device 120.

In step 430, the operation of storing sorted data in the buffer may be performed when the storage device 120 receives an instruction for reading the output data from the computer device (first mode), when the storage device 120 receives a merge instruction from the computer device (second mode), or when the storage device 120 is in an idle state in which the merge sort may be performed (third mode).

When sorted data is needed, the computer device 110 delivers an instruction for reading output data to the storage device 120, and the storage device 120 may provide the sorted data to the computer device in real time (first mode).

When sorted data is needed or preparation for the sorted data is needed, the computer device 110 may deliver a separate merge instruction to the storage device 120 (second mode). The first mode is an example in which the read instruction is used as one merge instruction.

The storage device 120 may perform a merge in an idle state in which the storage device 120 may perform a merge sort (third mode). In the third mode, the computer device 110 may be responsible for the control. Accordingly, the third mode may correspond to the second mode in which the computer device issues a separate merge sort instruction when the storage device 120 is in an idle state.

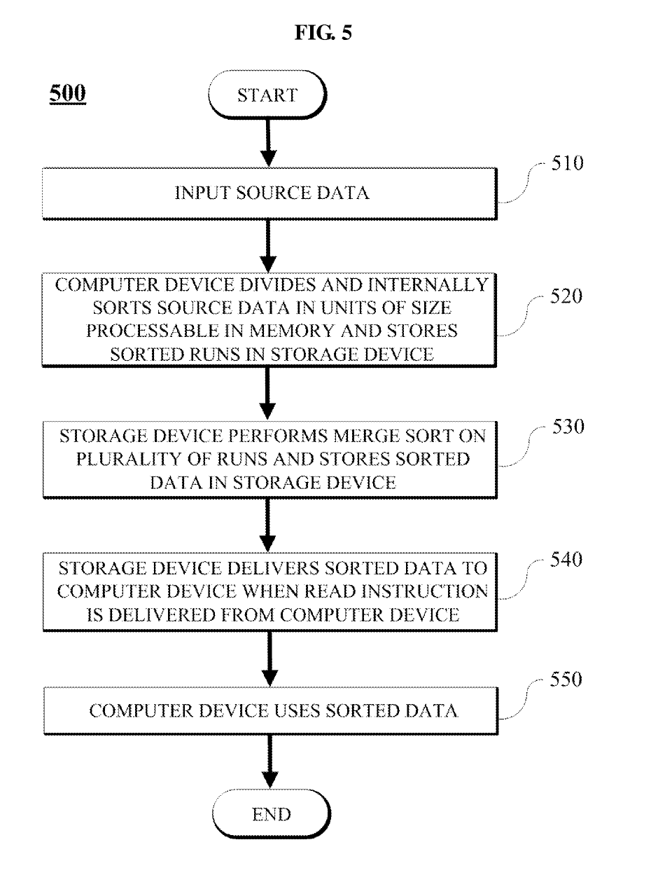

FIG. 5 is a flowchart illustrating another example of external merge sort method 500. The operations in FIG. 5 may be performed in the sequence and manner as shown, although the order of some operations may be changed or some of the operations omitted without departing from the spirit and scope of the illustrative examples described. Many of the operations shown in FIG. 5 may be performed in parallel or concurrently. The exemplary method 500 is different from the external merge sort method 400 of FIG. 4 in that data formed by merging the plurality of runs is stored in a storage of the storage device 120. Other than this, the remaining steps and elements are the same as in FIG. 4. The above descriptions of FIGS. 1-4, are also applicable to FIG. 5, and is incorporated herein by reference. Thus, the above description may not be repeated here.

The external merge sort method 500 includes inputting source data in step 510. Dividing and internally sorting, by a computing device, the source data in memory size units and storing the sorted runs in the storage device 120 in step 520. Performing, by the storage device 120, a merge sort on the plurality of runs and storing the sorted data in a main storage of the storage device 120 in step 530. Delivering, by the storage device 120, the sorted data to the computing device 110, in step 540, when the read instruction is delivered from the computing device 110. In step 550, the computing device 110 uses the sorted data.

In step 530, the storage device sequentially stores records included in the runs in the main storage thereof according to a key value of each record and a sort criterion. For an SSD, the main storage may correspond to a NAND flash memory. The process of merging and storing the plurality of runs (530) may be performed by the storage device 120 in advance, regardless of the read instruction of the computer device. In a case where the size of the source data is large, a delay may occur when the storage device 120 receives the read instruction of the computer device and then merges the runs. Accordingly, it is desirable to perform step 530 when the computer device delivers a separate merge instruction, not the read instruction (second mode) and when the storage device 120 is in an idle state (third mode).

In the external merge sort method 400 of FIG. 4 and the external merge sort method 500 of FIG. 5, the storage device 120 merges a plurality of runs and stores merged data independently. Accordingly, the storage device 120 needs a control element for a process of merging and storing a plurality of runs. The storage device 120 may use an element such as a memory or chip in which embedded software is installed.

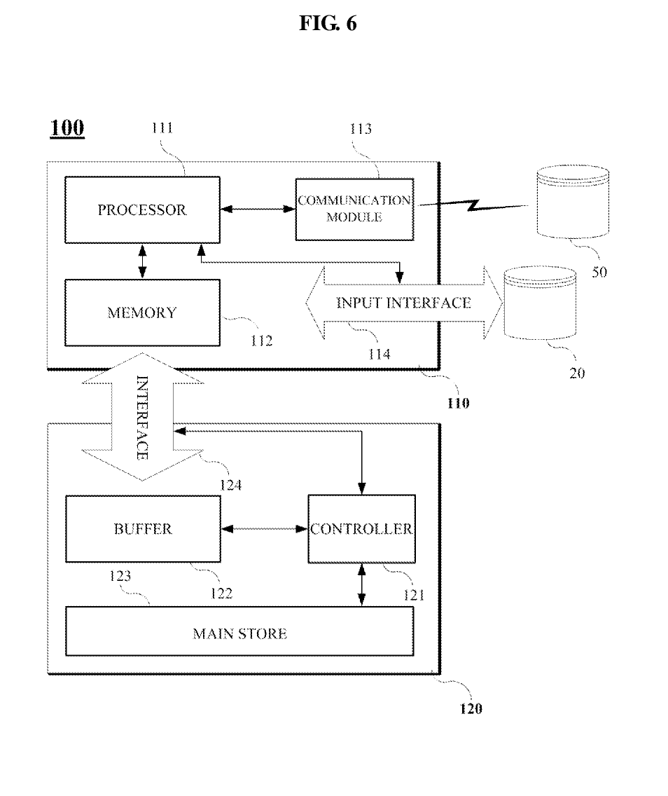

FIG. 6 is a diagram illustrating an example of external merge sort device 100. The external merge sort device 100 includes a host device 110 configured to store, in a storage device 120, a plurality of runs that are obtained by performing an internal sort on source data in units of a reference segment size that may be processed in a memory and deliver a merge sort instruction for the plurality of runs to the storage device 120. The storage device 120 receives the merge sort instruction, performs a merge sort on the plurality of runs, and delivers the sorted data to the host device 110.

The host device 110 includes a processor 111 to control the host device 110 and the storage device 120, a memory 112 to process data in an operation process, a communication module 113 to transmit and receive data over a network, and an input interface 114 to receive data or commands from a user. While components related to the present example are illustrated in the host device 110 and the storage device 120 of FIG. 6, it is understood that those skilled in the art may include other general components.

The storage device 120 includes a main store 123 to store runs and data, a buffer 122 to store sorted data, an interface 124 to deliver the sorted data stored in the buffer 122 to the host device 110, and a controller 121 to control the interface 124 such that records included in the runs are sequentially stored in the buffer 122 according to a key value of each record and a sort criterion and the data stored in the buffer 122 is delivered to the host device 110.

Initial source data may be delivered to the host device from the storage device 120 through the interface 124, delivered from a separate storage device 20 through the input interface 114, or delivered from a storage device 50 that is located in a remote region through the communication module 113. The interface 124 is responsible for data and signals transmitted and received between the storage device 120 and the host device 110. The interface 124 may be considered to be an element included in either or both the host device 110 and the storage device 120.

The host device 110 internally sorts source data that is stored in the memory 112 in memory size units, using the processor 111. An internally stored run is stored in the main store 123 of the storage device 120 through the interface 124.

The host device 110 delivers run information including at least one of a storage position of each run, a file size, a record size of data included in the run, a position of a key value, a length of a key value, and a record type to the storage device 120.

Various methods may be used to deliver the run information to the storage device 120. A new instruction for the information may be generated, or the information may be loaded to a reserved field of an instruction such as SATA and then sent. The information may be written in a specific region of the storage device 120 (through a write instruction) and then sent. If the storage device 120 supports an object-based interface, a file is managed inside the storage device 120, and thus information on the file may be found.

The storage device 120 performs a merge sort using the run information. As described above, the merge sort means selecting and storing a record having a highest priority according to a sort criterion with reference to all of the plurality of runs.

To quickly process a merge operation inside the storage device 120, reading data from the main store 123 may be processed in parallel with comparing key values of the records. Furthermore, a situation in which the records should be continuously copied in a specific file according to distribution of key values may occur. For this, a certain number of records may be read in advance.

The host device 110 may deliver a merge sort instruction to the storage device 120 when an access to the output data stored in the storage device 120 is needed or when the host device 110 and the storage device 120 are in an idle state.

The storage device 120 may store the data sorted by performing the merge sort in the buffer 122 and deliver the data stored in the buffer 122 to the host device 110 through the interface 124, or may store the data sorted by performing the merge sort in the main store 123 and deliver the data stored in the main store 123 to the host device 110 when a request is made by the host device 110.

When the storage device 120 delivers the data stored in the buffer 122 to the host device 110 in real time, the host device 110 may use the data directly without waiting until all of the data is read. A related art external merge sort technique may use the sorted data after recording all of the sorted data to prepare for situations such as an error or power-off.

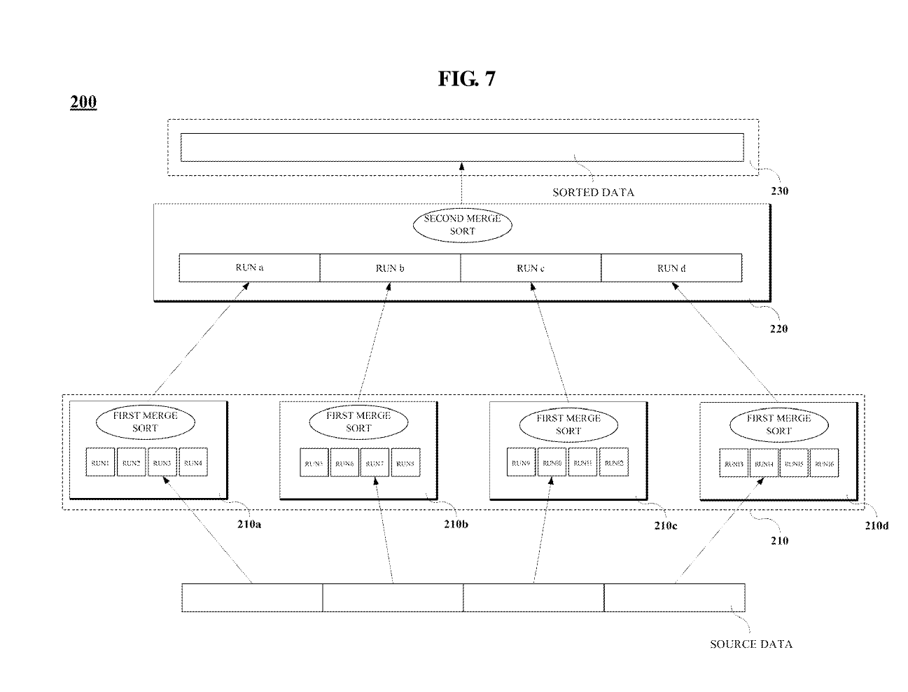

FIG. 7 is a diagram illustrating an example of distributed processing device 200 for external merge sort.

A distributed processing device 200 for external merge sort includes a plurality of first merge sort devices 210 and second merge sort device 220. The plurality of first merge sort devices 210 internally sort the first divided source data in units of a size that may be processed in a memory of each first merge sort device when source data is first divided and transmitted by each first merge sort device. The plurality of first merge sort devices 210 may store runs sorted in units of the size in a first storage device of each first merge sort device. The plurality of first merge sort devices 210 may perform a first merge sort on the runs to deliver the sorted data to a second merge sort device. The second merge sort device 220 receives the first merged and sorted data from each of the plurality of first merge sort devices and performs a second merge sort on the first merged and sorted data to store the second merged and sorted data in a second storage device of the second merge sort device.

In the distributed processing device 200 for external merge sort shown in FIG. 7, a process of merging source data is distributed to a plurality of merge sort devices. The distributed processing device 200 for external merge sort may be used to quickly process very large-scale data.

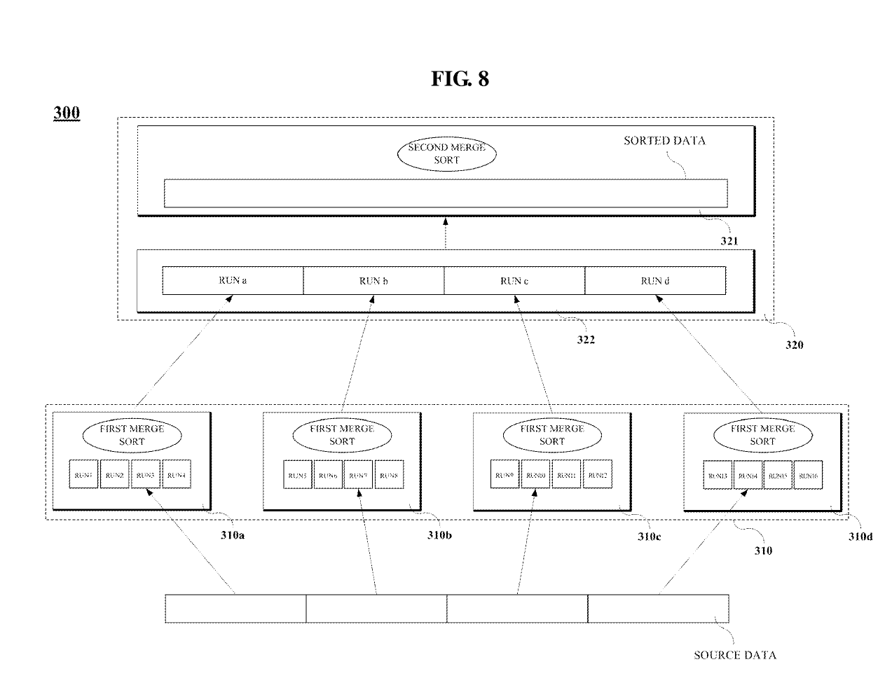

In the distributed processing device 200 for external merge sort shown in FIG. 7, the first merge sort device 210 and the second merge sort device 220 correspond to the storage device 120 illustrated in FIG. 6. In FIGS. 7 and 8, detailed configurations of respective merge sort devices are omitted. The above descriptions of FIG. 6, are also applicable to FIGS. 7 and 8, and is incorporated herein by reference. Thus, the above description may not be repeated here.

Initial source data is stored in a separate storage device, first divided in a size that can be processed by each first merge sort device 210, and then delivered to each first merge sort device 210. The first division may be performed by a host device 230.

The first merge sort devices 210a, 210b, 210c, and 210d internally sort the first-sorted and delivered source data in memory size units, and store the sorted runs in the main storage unit. For example, the first merge sort device 210a stores RUN1, RUN2, RUN3, and RUN4, the first merge sort device 210b stores RUN5, RUN6, RUN7, and RUN5, the first merge sort device 210c stores RUN9, RUN10, RUN11, and RUN12, and the first merge sort device 210d stores RUN13, RUN14, RUN15, and RUN16.

Each of the first merge sort devices 210 performs a process (a first merge) of merging the plurality of runs that are stored in the merge sort devices 210. The first merge sort device 210 may store a result of performing the first merge sort on the runs in a buffer and deliver data stored in the buffer to the second merge sort device 220 in real time. The first merge sort device 210 may store a result of performing the first merge sort on the runs in the first storage device and deliver the sorted data to the second merge sort device 220 when the sort is completed.

To perform the first merge sort, the first merge sort device 210 should secure run information including at least one of a storage position of each run, a file size, a record size of data included in the run, a position of a key value, a length of a key value, and a record type. The host device 230 may deliver the run information to the first merge sort device 210 while delivering the first divided source data.

The second merge sort device 220 corresponds to one storage device. The second merge sort device 220 may store all data delivered from the first merge sort device 220. FIG. 7 shows runs RUNa, RUNb, RUNc, and RUNd delivered from the first merge sort devices 210a, 210b, 210c, and 210d to the second merge sort device 220, respectively. Unlike the first merge sort device 210, the second merge sort device 220 and is responsible only for merging the delivered plurality of runs (second merge).

The second merge sort device 220 may secure run information on each of the runs delivered for the second merge sort (for example, in FIG. 7, RUNa, RUNb, RUNc, and RUNd). The host device 230 may deliver the run information. The first merge sort device 210 that delivers the runs may deliver the run information to the second merge sort device 220 directly.

The second merge sort device 220 may store a result of performing the second merge sort on the plurality of runs in a buffer and deliver data stored in the buffer to the host device 230 in real time. The second merge sort device 220 may store a result of performing the second merge sort on the runs in the second storage device and deliver the sorted data to the host device 230 when the sort is completed.

The host device 230 may control at least one of the first division of the source data, the first merge sort, the delivery of the runs, and the second merge sort. Although the first merge sort device 210 performs an internal sort in the description above, the host device 230 may perform the internal sort and store runs obtained through the internal sort in the first merge sort device 210. In this case, the first merge sort device 210 has the same configuration and performs the same functions as the storage device 120 described with reference to FIG. 6.

FIG. 8 is a diagram illustrating another example of distributed processing device 300 for external merge sort. In the distributed processing device 300 for external merge sort shown in FIG. 8, a host device 321 performs a second merge sort.

A distributed processing device 300 for external merge sort includes a plurality of first merge sort devices 310 and a second merge sort device 320. A plurality of first merge sort devices 310 internally sort the first divided source data in units of a size that may be processed in a memory of each first merge sort device when source data is first divided and transmitted by each first merge sort device. The plurality of first merge sort devices 310 stores runs sorted in units of the size in a first storage device of each first merge sort device, and performs a first merge sort on the runs to deliver the sorted data to a second merge sort device. A second merge sort device 320 receives the first merged and sorted data from each of the plurality of first merge sort devices and performs a second merge sort on the first merged and sorted data to store the second merged and sorted data in a second storage device of the second merge sort device.

The second merge sort device 320 includes the host device 321 configured to perform a second merge sort and a second storage device 322 configured to store runs to be merged and sorted.

The first merge sort device 310 does not perform an internal sort autonomously, and the host device 321 may perform the internal sort to store a plurality of runs in the first merge sort device 310. In this case, the first merge sort device 310 has the same configuration and performs the same functions as the storage device 120 described with reference to FIG. 6. The above descriptions of FIG. 6, are also applicable to FIG. 8, and is incorporated herein by reference. Thus, the above description may not be repeated here.

At least one of the first storage device and the second storage device may use a storage medium configured as a non-volatile memory or flash memory.

The above-described external merge sort device 100 or distributed process device 200 for external merge sort may be used in a device for processing large-scale data, such as, for example, a Hadoop system, a data base system.

The above-described external merge sort device 100 or distributed process device 200 for external merge sort can reduce an overhead of the host device and efficiently perform the external merge sort by distributing the external merge sort to the host device and the storage device.

Furthermore, the above-described external merge sort device 100 or distributed process device 200 for external merge sort increases a life of the storage device by reducing the number of reads and writes of the storage device during the external merge sort process. When a solid state disk (SSD) configured as a flash memory is used as the storage device, a life of the SSD is increased by twice as much.

The processes, functions, and methods described above can be written as a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device that is capable of providing instructions or data to or being interpreted by the processing device. The software also may be distributed over network coupled computer systems so that the software is stored and executed in a distributed fashion. In particular, the software and data may be stored by one or more non-transitory computer readable recording mediums. The non-transitory computer readable recording medium may include any data storage device that can store data that can be thereafter read by a computer system or processing device. Examples of the non-transitory computer readable recording medium include read-only memory (ROM), random-access memory (RAM), Compact Disc Read-only Memory (CD-ROMs), magnetic tapes, USBs, floppy disks, hard disks, optical recording media (e.g., CD-ROMs, or DVDs), and PC interfaces (e.g., PCI, PCI-express, WiFi, etc.). In addition, functional programs, codes, and code segments for accomplishing the example disclosed herein can be construed by programmers skilled in the art based on the flow diagrams and block diagrams of the figures and their corresponding descriptions as provided herein.

The apparatuses and units described herein may be implemented using hardware components. The hardware components may include, for example, controllers, sensors, processors, generators, drivers, and other equivalent electronic components. The hardware components may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The hardware components may run an operating system (OS) and one or more software applications that run on the OS. The hardware components also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a hardware component may include multiple processors or a processor and a controller. In addition, different processing configurations are possible, such a parallel processors.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An external merge sort method comprising:
storing, by a computer device, a plurality of runs in a storage device, the plurality of runs being obtained by dividing and internally sorting source data according to a size processable in a memory;
performing, by the storage device, a merge sort on the stored runs using embedded software; and
accessing, by the computer device, the sorted data.

2. The external merge sort method of claim 1, further comprising, delivering, by the computer device, run information comprising a storage position and a file size of each of the plurality of runs to the storage device, before the performing of the merge sort.

3. The external merge sort method of claim 2, wherein the run information further comprises at least one of a record size of data included in the run, a position of a key value, a length of a key value, or a record type.

4. The external merge sort method of claim 1, wherein the performing of the merge sort comprises sequentially storing, by the storage device, records included in the runs in a buffer or main storage medium of the storage device according to a key value of each record and a sort criterion.

5. The external merge sort method of claim 1, wherein the performing of the merge sort occurs in response to the storage device receiving an instruction to read output data from the computer device, or in response to the storage device receiving a merge instruction from the computer device, or in response to the storage device being in an idle state in which the merge sort is enabled.

6. The external merge sort method of claim 1, wherein in the performing of a merge sort, the storage device stores the sorted data in a buffer in units of a size of the buffer, and
wherein in the accessing of the merged and sorted data, the computer device receives the data stored in the buffer in units of the size of the buffer.

7. The external merge sort method of claim 1, wherein in the performing of the merge sort, the storage device stores the sorted data in a main storage medium, and
wherein in the accessing of the merged and sorted data, the computer device reads the data stored in the main storage medium.

8. The external merge sort method of claim 1, wherein the storage device is a non-volatile memory or flash memory.

9. An external merge sort system comprises:
a host device configured to store a plurality of runs in a storage device, the plurality of runs being obtained by performing an internal sort on source data in units of a reference segment size processable in a memory and to deliver a merge sort instruction for the plurality of runs to the storage device; and
a storage device configured to receive the merge sort instruction, to perform a merge sort on the plurality of runs, and to deliver the sorted data to the host device.

10. The external merge sort system of claim 9, wherein the host device receives the source data from the storage device, a separate storage device, or a storage device connected over a network.

11. The external merge sort system of claim 9, wherein the host device delivers run information comprising at least one of a storage position of each run, a file size, a record size of data included in the run, a position of a key value, a length of a key value, or a record type to the storage device, and
wherein the storage device performs the merge sort using the run information.

12. The external merge sort system of claim 9, wherein the storage device comprises:
a main store configured to store the runs;
a buffer configured to store the sorted data;
an interface configured to deliver the sorted data stored in the buffer to the host device; and
a controller configured to control the interface to sequentially store the records included in the runs in the buffer according to a key value of each record and a sort criterion and to deliver the data stored in the buffer to the host device.

13. The external merge sort system of claim 9, wherein the host device delivers the merge sort instruction to the storage device in response to an access to output data stored in the storage device being needed or in response to the storage device being in an idle state.

14. The external merge sort system of claim 9, wherein the storage device stores the data sorted by performing the merge sort in a buffer and delivers the data stored in the buffer to the host device, or
stores the data sorted by performing the merge sort in a main storage medium and delivers the data stored in the main storage medium to the host device in response to a request by the host device.

15. A distributed processing system for external merge sort comprising:
first merge sort devices configured to internally sort first-divided source data in units of a size processable in a memory of each first merge sort device in response to source data being first-divided and transmitted by each first merge sort device, to store the runs sorted in units of the size in a first storage device, and to perform a first merge sort on the runs to deliver the sorted data to the second merge sort device; and
a second merge sort device configured to receive the first merged and sorted data from each of the first merge sort devices and to perform a second merge sort on the first merged and sorted data to store the sorted data in a second storage device.

16. The distributed processing system of claim 15, wherein the first merge sort device is further configured to store a result of performing the first merge sort in a buffer and to deliver the data stored in the buffer to the second merge sort device, or
to store a result of performing the first merge sort on the runs in a first storage device and to deliver the sorted data to the second merge sort device when the sort is completed.

17. The distributed processing system of claim 15, further comprising a host device configured to control at least one of the first division of the source data, the first merge sort, the delivery of the runs, or the second merge sort.

18. The distributed processing system of claim 17, wherein the host device delivers run information comprising at least one of a storage position of each run, a file size, a record size of data included in the run, a position of a key value, a length of a key value, or a record type to the first merge sort device, and
wherein the first merge sort device performs the first merge sort independently using the run information.

19. The distributed processing system of claim 15, wherein the second merge sort device is a host device, and the host device stores the first merge sort data in the second storage device and performs the second merge sort using the first merged and sorted data that is stored in the second storage device.

20. The distributed processing system of claim 15, wherein at least one of the first storage device and the second storage device is a non-volatile memory or flash memory.
